(19) United States
(12) Patent Application Publication
(10) Pub. No.: US 2011/0131177 A1
(43) Pub. Date: Jun. 2, 2011

(54) METHOD AND SYSTEM FOR PROVIDING RAPID UPDATING OF SERVICES IN AN IMS ENVIRONMENT

(76) Inventors: NIRAL S. SHETH, Austin, TX (US); ARSHAD ` KHAN, Austin, TX (US); CHAOXIN QIU, Austin, TX (US)

(21) Appl. No.: 12/628,797

(22) Filed: Dec. 1, 2009

(51) Int. Cl. G06F 15/16; G06F 17/30

(52) U.S. Cl. 707/609; 709/207; 370/352; 707/E17.005

(57) ABSTRACT

A method and a system for creating or updating a plurality of user profiles in an IMS network are disclosed. For example, the method generates a service profile, wherein the service profile comprises a new service profile or an updated service profile having a service profile type identifier. The method sends, via an update message, the service profile to at least one network element that is used to support at least one service defined by the service profile for updating a plurality of user profiles maintained by the at least one network element.

The present disclosure relates generally to communication networks and, more particularly, to a method and system for updating subscriber service profiles in an Internet Protocol (IP) Multimedia Subsystem (IMS).

### BACKGROUND

In the existing 3^{rd} Generation Partnership Project (3GPP) IMS architecture, adding new services/capabilities or changing existing services of a subscriber may require, among other things: changing the subscriber profile stored in a Home Subscription Server (HSS), sending the new subscriber profile by the HSS to a S-CSCF (Serving-Call Session Control Function server) serving the subscriber via a Diameter PPR (Push Profile Request) message over the Cx interface and to any Application Servers (ASs) that may have subscribed to the user profile via a PNR (Push Notification Request) command on the Sh interface. In turn, these IMS network elements will respond by sending a PPA/PNA (Push Profile Answer/Push Notification Answer) acknowledgement back to the HSS, where the HSS will then update its own database. This 3GPP mechanism results in at least two notifications being sent along with at least two corresponding responses for each subscriber profile that is being updated, which can be problematic.

For example, if a network operator wants to add/update a service for all or a large percentage of its subscribers, it could entail four messages per subscriber being exchanged where only one Application Server has subscribed to the user profile in addition to a S-CSCF. To illustrate, for a million subscribers supported by a service provider of a large network, this could result in millions of messages to be exchanged in a short period of time and may cause overloading of resources in the HSS, S-CSCFs and/or Application Servers and hamper network performance. Additionally, due to the sheer volume of messages, it may be very difficult to monitor for errors. As an alternative, a network service provider may deploy the update signaling messages over a period of time, for example, by staggering update messages over particular areas (e.g., from east to west and so on), by phone number (e.g., in a sequential manner based on area codes), or in any other fashion. However, this results in taking a very long time to implement/deploy services and may result in subscriber dissatisfaction.

### SUMMARY

In one embodiment, the present disclosure discloses a method and a system for creating or updating a plurality of user profiles in an IMS network. For example, the method generates a service profile, wherein the service profile comprises a new service profile or an updated service profile having a service profile type identifier. The method sends, via an update message, the service profile to at least one network element that is used to support at least one service defined by the service profile for updating a plurality of user profiles maintained by the at least one network element.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2 illustrates a flowchart of a method for creating or updating a service profile;

FIG. 3 illustrates a flowchart of a method for receiving and updating subscriber service profiles stored at a network element; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, an apparatus and a computer readable medium for updating subscriber service profiles in an IP Multimedia Subsystem (IMS). Although the present disclosure is discussed below in the context of Internet Protocol (IP) Multimedia Subsystem (IMS) networks, the present disclosure is not so limited. Namely, the present disclosure can be applied to any packet networks that may employ the present method for updating subscriber service profiles.

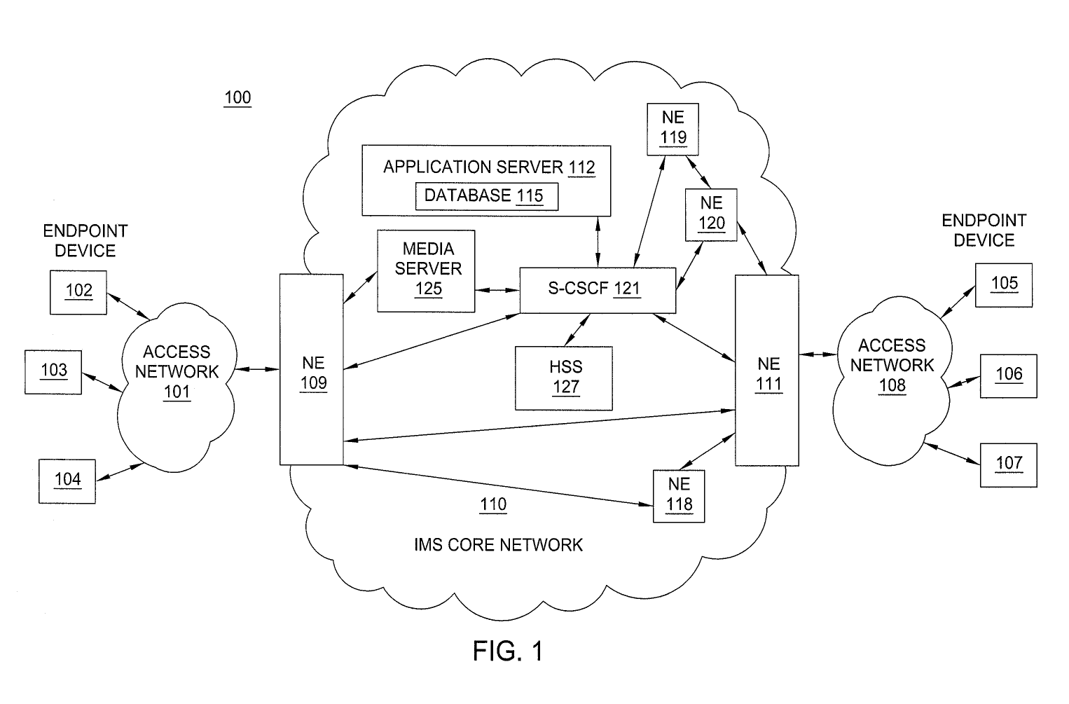

To better understand the present disclosure, FIG. 1 illustrates an illustrative network 100, e.g., an Internet Protocol (IP) Multimedia Subsystem network related to the present disclosure. An IP network is broadly defined as a network that uses Internet Protocol to exchange data packets.

In one embodiment, the network 100 may comprise a plurality of endpoint devices 102-104 configured for communication with the core IMS network 110 (e.g., an IP based core backbone network supported by a service provider) via an access network 101. Similarly, a plurality of endpoint devices 105-107 are configured for communication with the IMS core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), mobile phones, smart phones, email devices, messaging devices, and the like. The access networks 101 and 108 serve as a conduit to establish a connection between the endpoint devices 102-107 and the Network Elements (NEs) 109 and 111 of the IMS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IMS core network 110, or indirectly through another network.

Some NEs (e.g., NEs 109 and 111) reside at the edge of the IMS core infrastructure and interface with customer endpoints over various types of access networks. An NE that resides at the edge of a core infrastructure is typically implemented as an edge router, a media gateway, a proxy server, a border element, a firewall, a switch, and the like. An NE may also reside within the network (e.g., NEs 118-120) and may be used as a SIP server, a core router, or like device.

The IMS core network 110 also comprises a Home Subscriber Server (HSS) 127, a Serving—Call Session Control Function (S-CSCF) 121, a media server 125, and an Application Server 112 that contains a database 115. An HSS 127 refers to a network element residing in the control plane of the IMS network that acts as a central repository of all customer specific authorizations, service profiles, preferences, etc.

The S-CSCF 121 resides within the IMS core infrastructure and is connected to various network elements (e.g., NEs 109 and 111) using the Session Initiation Protocol (SIP) over the underlying IMS based core backbone network 110. The S-CSCF 121 may be implemented to register users and to provide various services (e.g., VoIP services). The S-CSCF interacts with the appropriate VoIP service related applications servers (e.g., 112) when necessary. The S-CSCF 121 performs routing and maintains session timers. The S-CSCF may also interrogate an HSS to retrieve authorization, service information, user profiles, etc. In order to complete a call that requires certain service specific features, the S-CSCF may need to interact with various application servers (e.g., various SIP servers). For example, the S-CSCF may need to interact with another server for translation of an E.164 voice network address into an IP address, and so on.

The Media Server (MS) 125 is a special server that typically handles and terminates media streams to provide services such as announcements, bridges, and Interactive Voice Response (IVR) messages for VoIP service applications. The media server also interacts with customers for media session management to accomplish tasks such as process requests.

The application server 112 may comprise any server or computer that is well known in the art, and the database 115 may be any type of electronic collection of data that is also well known in the art. In one embodiment, the database 115 may store subscriber profile data subscribed to by the application server 112, as discussed below. Those skilled in the art will realize that the communication system 100 may be expanded by including additional endpoint devices, access networks, network elements, application servers, etc. without altering the scope of the present disclosure.

The above IP network is described to provide an illustrative environment in which packets for voice, data and multimedia services are transmitted on networks. The current disclosure discloses a method and system for updating subscriber service profiles in an exemplary communication network (e.g., an IMS network) illustrated in FIG. 1 and as described below.

In existing IMS networks, for example the 3^{rd} Generation Partnership Project (3GPP) IMS network architecture, a Home Subscriber Server (HSS) comprises a database storing user profiles associated with a service provider's subscribers. The user profiles contain various information pertaining to the IMS users, e.g., each IMS subscriber (i.e., a user) has a unique private ID. Furthermore, each user profile may include one or more service profiles associated with the respective subscriber. For example, the service profile may comprise the initial filter criteria (also known as triggers), core network service authorizations (relating to security), and a public identity (e.g., one or more numbers). Associated with each of the triggers in the subscriber profile is a respective action. For example, the subscriber profile may indicate which servers to route through, in which order, and based upon what conditions.

As mentioned above, a HSS in the IMS network may serve as a central repository of all customer specific authorizations, service profiles, preferences, etc. In addition, one or more S-CSCFs may also interrogate the HSS to retrieve authorization, service information, user profiles, etc. In other words, a S-CSCF may download during registration the user profile of a subscriber maintained by the HSS. In addition, the HSS notes which S-CSCF has downloaded a subscriber's user profile. Accordingly, when the subscriber's service profile within the user profile is updated, changed or deleted within the HSS, the HSS, knowing that the S-CSCF has previously downloaded that subscriber's user profile, will transmit the updated user profile to the pertinent S-CSCF.

The S-CSCF may maintain its own database, e.g., in a local memory, an external memory, a database server or other storage device integral or coupled to the S-CSCF, which locally stores user profiles/subscriber profiles. Accordingly, upon downloading a subscriber's user profile with the HSS, the S-CSCF receives a copy of the subscriber's user profile from the HSS. The S-CSCF may store the copy of the user profile which it will use in various ways as will be described below. In addition, when the subscriber's service profile within the user profile is updated, changed or deleted, the S-CSCF receives an updated or changed user profile from the HSS. Upon receipt, the S-CSCF may overwrite or change its locally stored copy of the subscriber's user profile.

As mentioned above, the S-CSCF may use the subscriber service profile contained in the user profile in various ways. For example, in order to complete a call that requires certain service specific features, the S-CSCF may need to interact with various application servers (e.g., various SIP servers). For example, the S-CSCF may need to interact with an Application Server to provide supplementary services, e.g., call forwarding, and so on. In particular, the S-CSCF may use the triggers and specified actions that are contained in a subscriber service profile that indicate which servers to route through, in which order, and based upon what conditions.

Under the current 3GPP standard architecture, the S-CSCFs and/or Application Servers that download/subscribe to subscriber's user profiles from the HSS have no idea that many other subscribers (e.g., millions of other subscribers) may share the same service profile as defined within a particular user profile. In other words, multiple users, which may reach into the millions, may share the same service profile type. For example, if the users' service profiles share identical features, then the service profiles are of the same service profile type. However, the IMS network elements (e.g., an S-CSCF or AS) that are going to download this subscriber's user profile on a per subscriber basis have no notion of a service profile type within the user profile itself because there is no mechanism to commonly refer to the service profile type.

In one embodiment, the present disclosure creates a new data type referred to as a service profile type identifier, or a service profile ID. Accordingly, users provisioned with the same type of service(s) can now be associated with a service profile ID that identifies the common service profile type. The service profile ID may comprise simply an integer, a letter, a string of characters, or any other unique identifier. For example, one service profile type may be assigned a service profile ID of “1.” A different service profile type may be assigned a service profile ID of “2” and so on.

Additionally, in one embodiment a new field is created within the subscriber service profile (e.g., the tServiceProfile data structure as defined by the IMS standard). The new entry may be referred to herein as “tSPID” (shorthand for “service profile ID”). However, it should be understood that the field name may be arbitrary assigned while maintaining the same functionality in accordance with the present disclosure. The tSPID, having been created, may then be used to store the service profile ID that is associated with the subscriber service profile type of that particular subscriber. Advantageously, by including a service profile ID as a field within the subscriber service profile itself, the subscriber service profile type information may be conveyed to other IMS network elements (e.g., S-CSCF, AS and the like) within the contents of the subscriber service profile.

In one embodiment, the novel user of a service profile ID contained in the subscriber service profile enables a more efficient subscriber service profile update across a network via IMS network elements such as the HSS, Application Servers and S-CSCFs, as will be explained in greater detail below. Broadly, the service profile ID as embodied within the user profile will be transmitted to other IMS network elements via an update message. The update message is broadly a message informing a receiving IMS network element to update a subscriber's user profile.

More specifically, in one embodiment, a new message type, referred to herein as a Mass Update Request (MUR) message is defined in accordance with, e.g., the Diameter protocol, which contains an indication that it applies to all subscribers. To illustrate, the HSS may transmit a MUR that contains an updated service profile (e.g., to include new triggers/actions in response to the addition of a new network service or an update to an existing network service) along with an indication that it applies to all subscribers. Furthermore, the updated service profile will include a service profile ID as discussed above (which identifies the subscriber service profile type).

Upon receipt of the MUR message, in one embodiment the S-CSCF or the Application Server is configured to use this information to update the service profile of all subscribers within its local database that are of the subscriber service profile type that is the subject of the MUR message. In particular, the tSIPD or service profile ID stored in the updated service profile indicates to the S-CSCF or AS which subscribers' service profiles are affected by the MUR. Since the MUR is indicated as applying to all service profiles, the S-CSCF or AS will scan its entire database, and any service profile that has a service profile ID (tSPID) that matches the tSPID of the updated service profile in the MUR will be changed or overwritten with the new, updated service profile.

Upon successfully updating its local database, the AS or S-CSCF may begin routing calls for the affected subscribers as specified by the updated filter criteria/routing logic to take advantage of the new or updated service. In addition, upon successfully updating its local database, the AS or S-CSCF may send an acknowledgment message back to the HSS indicating a successful local update of the affected subscriber service profiles.

In summary, the ID of a service profile type is included into the service profile itself, e.g., a field is created in the service profile and downloaded to the S-CSCF/AS as part of the schema of the service profile. Notably, the service profile ID type of the subscriber service profile is made known to the IMS network elements along with the additional contents of the updated service profile. Thus, when a IMS network element (e.g., an AS or S-CSCF) receives a service profile update for a particular service profile type, the IMS network element will apply the update to all subscribers that match the service profile ID in the new service profile transmitted in the MUR. Advantageously, only two messages (a first MUR message received from the HSS and a second response message to the MUR sent to the HSS) are required to update all of the user profiles stored locally at an Application Server or S-CSCF that share the same service profile type. For example, if a S-CSCF locally supports 10,000 subscribers and the received MUR affects 5,000 of those 10,000 subscribers, only two (2) messages are sent between the S-CSCF and the HSS to effect updates of 5,000 user profiles for supporting an update or a new service provided by the network service provider. Under the existing architecture, 10,000 messages must be exchanged between the S-CSCF and the HSS to achieve the same result.

If a large network employs hundreds of S-CSCF or Application Server elements, the number of messages to effect the service change as described in the present disclosure is minimal as compared to the staggering number of messages that must be exchanged to achieve the same result in the existing architecture. Aside from the savings in the number of exchanged messages, the present disclosure greatly reduces the time required to deploy a new or updated service.

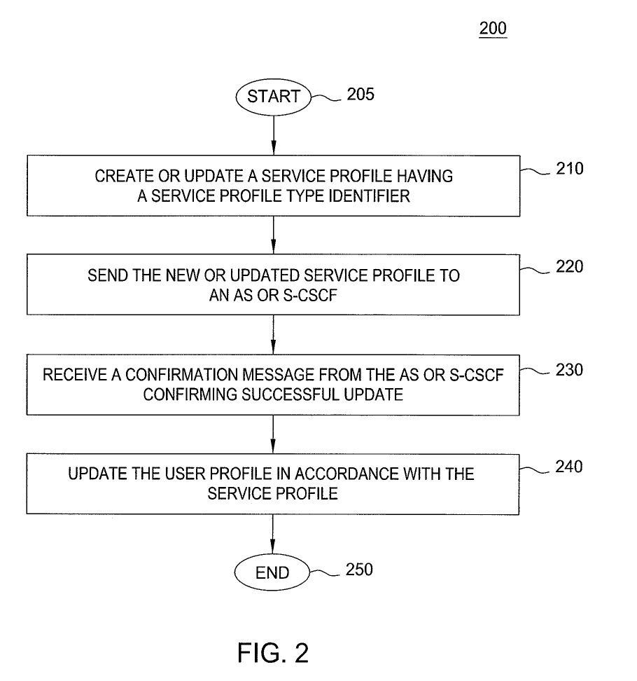

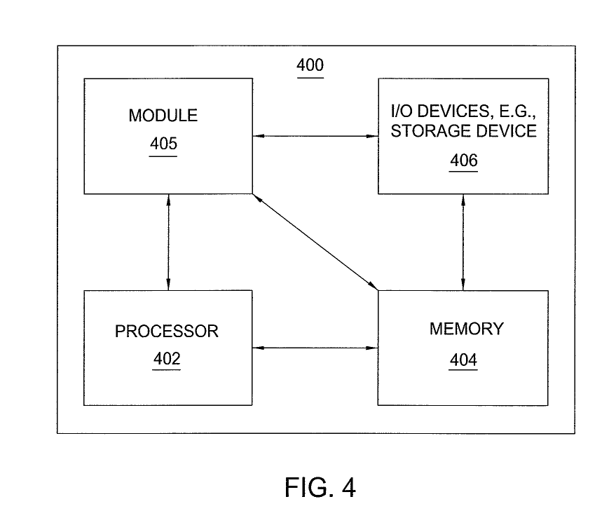

FIG. 2 illustrates a flowchart of a method 200 for creating or updating a service profile in an IMS network. In one embodiment, one or more steps of the method 200 can be implemented by the HSS 127 or a general purpose computer having a processor, a memory and input/output devices as illustrated below in FIG. 4. The method 200 begins at step 205.

At step 210, the method 200 creates or updates a subscriber service profile with a subscriber service profile type identifier. In one embodiment, the subscriber service profile type identifier may be a tSPID, as discussed above. At step 210, the method creates or updates a subscriber service profile having a subscriber service profile type identifier (e.g., in response to a new service or an update to an existing service provided by a network service provider). In one embodiment, the creating or updating of a subscriber service profile of step 210 may be performed, at or by an HSS, such as HSS 127 in FIG. 1, serving as a central repository for user/subscriber data.

By way of an example, a network service provider may desire to add a new service or make a change to an existing network service. In the case of a new service, the network provider may deploy a new application server to support the new service. In one embodiment, a subscriber service profile type with tSPID “silver” exists which may define, for example, three services to be provided to a subscriber. In the present example, the new service will be used in processing calls for subscribers having a subscriber service profile type identified by the service profile ID “silver”, i.e., a new service will be added to the subscriber service profile type, “silver.” For example, subscribers who previously subscribed to the “silver” class of services may receive a new fourth service that is being bundled with the “silver” class of services.

Therefore, triggers and actions relating to the new service should be accounted for within the subscriber service profile type having a service profile ID of “silver.” For instance, the old subscriber service profile type “silver” may specify that for all incoming calls, the call should be routed to Application Server ABC prior to routing the call to the subscriber. The new service may be deployed via a new Application Server XYZ. Accordingly, the updated service profile may specify the additional trigger for routing a call to the AS ABC, then to the new AS XYZ to obtain the new service logic before the call is setup to the subscriber.

At step 220, the method sends the new or updated service profile to an IMS network element, e.g., an Application Server or S-CSCF in the network. In one embodiment, the sending of a service profile of step 220 may be performed, at or by an HSS, such as HSS 127 in FIG. 1. For example, S-CSCF 121 and/or an AS 112 may download/subscribe to various user profiles with HSS 127. When a subscriber service profile of a type identified by a particular tSPID is updated, an update message will be sent to the relevant IMS network elements such as the S-CSCF 121 or AS 112 by the HSS 127. The update message may comprise a Mass Update Request (MUR) which identifies that it relates to all user profiles and includes the new subscriber service profile for a particular subscriber service profile type (e.g., “silver”). Upon receipt of such update message, the AS 112 and/or S-CSCF 121 will update its own local database of user profiles by updating all subscriber service profiles that have a tSPID matching that of the subscriber service profile specified in the MUR. It should be noted that the MUR does not have to identify a particular user.

At step 230, the method receives a confirmation message from the IMS network element of a successful update. For example, HSS 127 receives a confirmation from AS 112 or S-CSCF 121 of a successful mass update, in response to the update message (e.g., a MUR message) communicating a change/update to user profiles of the subscriber service profile type that is identified by the tSPID “silver.” In one embodiment, the message from the AS 112 may comprise a Diameter message such as a PNA (Push Notification Answer), or a PPA (Push Profile Answer) from the S-CSCF 121.

At step 240, the method updates the pertinent user profiles in accordance with the new subscriber service profile. For example, although the new subscriber service profile that is created or updated in step 210 is sent by the HSS 127, the user profiles stored locally at the HSS that are affected by the new subscriber service profile are actually not updated yet. When the IMS network element (the S-CSCF or AS) successfully updates its own database, it sends a successful update message which is received by the HSS. In one embodiment, upon successful receipt of the response message, the HSS may then update its own database for those subscribers associated with the received response. For example, a HSS may have one million user profiles, where a response from a particular S-CSCF may only be pertinent to 10,000 subscribers serviced by that particular S-CSCF. Upon receipt of a confirmation in response to a MUR message from that particular S-CSCF, the HSS will then only update its records pertaining to those subscribers serviced by that particular S-CSCF. In this manner, the HSS conforms its own records to the user profiles that are stored throughout the network in the local databases of the IMS network elements such as S-CSCFs, Application Servers and the like. The method ends in step 250.

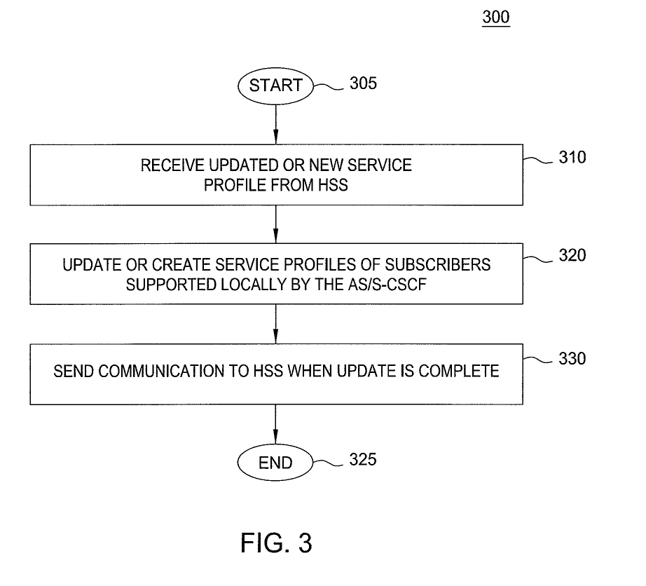

FIG. 3 illustrates a flowchart of a method 300 for creating or updating a service profile in an IMS network. In one embodiment, one or more steps of the method 300 can be implemented by an IMS network element, e.g., an Application Server or S-CSCF, such as AS 112 or S-CSCF 121 in FIG. 1, or a general purpose computer having a processor, a memory and input/output devices as illustrated below in FIG. 4. The method begins in step 305.

At step 310, the method receives an updated or new subscriber service profile along with an update message from the HSS 127. For example, a network provider may desire to add a new network service or make a change to an existing network service.

At step 320, the method updates or creates user profiles supported locally by an AS or S-CSCF. For example, an AS or S-CSCF may receive an update message, such as a MUR message, specifying an updated/new subscriber service profile for subscriber service profiles of a type identified by a particular tSPID, such as “silver.” In one embodiment, the MUR message may contain an indication that it relates to all user profiles. In addition, the MUR message includes a new subscriber service profile which includes a service profile ID, or tSPID, indicating the subscriber service profile type to which the new/updated subscriber service profile applies. In order to use the updated/new subscriber service profile, the AS or S-CSCF must update its own local database storing the user profiles.

Upon receipt of the update message, the IMS network element must determine which user profiles the MUR message applies to. In one embodiment, the IMS network element scans its local database, and examines the tSPID for each record. Where there is a match between the tSPID of a current record and the tSPID of the subscriber service profile conveyed by the MUR message, the IMS network element will update or overwrite the existing record with the new subscriber service profile from the MUR message. If there is no match between the tSPID of a current record and the tSPID of the subscriber service profile in the MUR message, the IMS network element will simply move on to the next entry in the database. In this manner, the IMS network element may rapidly update the user profiles relating to all users/subscribers sharing the common subscriber service profile type identified by the tSPID contained in the new subscriber service profile in the MUR message. It should be noted that although the process has been described in one embodiment as a sequential search, the present disclosure is not so limited. Any other search/update algorithms used in updating records in a database are contemplated by the current disclosure. In addition, it should be noted that a local database at an IMS network element (e.g., an AS or S-CSCF) may comprise any permanent or temporary storage medium such as magnetic or optical storage media, RAM, Zip Drive, Tape Drive, diskette, CD-ROM, or similar storage devices, and may be internal, external or in a distributed location from the IMS network element itself, any such variation being within the scope of the present disclosure.

In step 330, the method sends a communication to the HSS when updating subscriber service profiles is complete (or a message that the update was not successful, e.g., due to an error). In one embodiment, the message, which may comprise a Diameter message such as PPA or PNA, is sent by an IMS network element, such as AS 112 or S-CSCF 121, to the HSS 127. The method ends in step 325. Accordingly, the HSS upon receipt of the acknowledgment or confirmation message from the AS or S-CSCF of the successful mass-update of user profiles, will then update its own database. Therefore, according to this embodiment it is important for the AS or S-CSCF, upon successful completion of updating its own user profile records, to convey such successful completion back to the HSS.

It should be noted that although not specifically specified, one or more steps of methods 200 and 300 may include a storing, displaying and/or outputting step as required for a particular application. In other words, any data, records, fields, and/or intermediate results discussed in the method can be stored, displayed and/or outputted to another device as required for a particular application.

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for creating or updating a service profile, or for sending or receiving a service profile, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents. In one embodiment, the present module or process 405 for creating a social network map using non-voice communications can be loaded into memory 404 and executed by processor 402 to implement the functions as discussed above. As such, the present method 405 for creating or updating a service profile, or for sending or receiving a service profile (including associated data structures) of the present disclosure can be stored on a computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for processing a user profile in a communication network, comprising:
generating a service profile, wherein the service profile comprises a new service profile or an updated service profile having a service profile type identifier; and
sending, via an update message, the service profile to at least one network element that is used to support at least one service defined by the service profile for updating a plurality of user profiles maintained by the at least one network element.

2. The method of claim 1, wherein the communication network comprises an Internet Protocol (IP) Multimedia Subsystem IMS network.

3. The method of claim 1, wherein said sending is performed by a Home Subscriber Server.

4. The method of claim 1, wherein the service profile comprises routing instructions that the at least one network element uses to process a call relating to a subscriber having the service profile.

5. The method of claim 1, further comprising:
receiving a confirmation from the at least one network element that a plurality of user profiles has been successfully updated or changed in accordance with the update message.

6. The method of claim 5, further comprising:
updating a local database of user profiles in response to said confirmation.

7. The method of claim 1, wherein the service profile is common to a plurality of subscribers, and wherein the service profile is distinguished from other service profiles by the service profile type identifier.

8. The method of claim 7, wherein the service profile type identifier is stored in a data field of said service profile.

9. The method of claim 1, wherein the at least one network element comprises at least one of: a Serving-Call Session Control Function (S-CSCF) network element or an application server.

10. A computer-readable storage medium having stored thereon a plurality of instructions, the plurality of instructions including instructions which, when executed by a processor, cause the processor to perform steps of a method for processing a user profile in a communication network, comprising:
generating a service profile, wherein the service profile comprises a new service profile or an updated service profile having a service profile type identifier; and
sending, via an update message, the service profile to at least one network element that is used to support at least one service defined by the service profile for updating a plurality of user profiles maintained by the at least one network element.

11. The computer-readable storage of claim 10, wherein the communication network comprises an Internet Protocol (IP) Multimedia Subsystem IMS network.

12. The computer-readable storage of claim 10, wherein said sending is performed by a Home Subscriber Server.

13. The computer-readable storage of claim 10, wherein the service profile comprises routing instructions that the at least one network element uses to process a call relating to a subscriber having the service profile.

14. The computer-readable storage of claim 10, further comprising:
receiving a confirmation from the at least one network element that a plurality of user profiles has been successfully updated or changed in accordance with the update message.

15. The computer-readable storage of claim 14, further comprising:
updating a local database of user profiles in response to said confirmation.

16. The computer-readable storage of claim 10, wherein the service profile is common to a plurality of subscribers, and wherein the service profile is distinguished from other service profiles by the service profile type identifier.

17. The computer-readable storage of claim 16, wherein the service profile type identifier is stored in a data field of said service profile.

18. The computer-readable storage of claim 10, wherein the at least one network element comprises at least one of: a Serving-Call Session Control Function (S-CSCF) network element or an application server.

19. A method for processing a user profile in a communication network, comprising:
receiving via an update message a service profile by a network element, wherein said service profile comprises a new service profile or an updated service profile having a service profile type identifier; and
updating a plurality of user profiles in accordance with said service profile type identifier.

20. The method of claim 19, wherein the network element comprises at least one of: a Serving-Call Session Control Function (S-CSCF) network element or an application server.
